(19) United States
(12) Patent Application Publication
(10) Pub. No.: US 2022/0220295 A1
(43) Pub. Date: Jul. 14, 2022

(54) Cross-Linkable Fluoropolymer Compositions

(71) Applicant: Tyco Electronics UK LTD, Wiltshire (GB)

(72) Inventors: Sreeni Kurup, Wiltshire (GB); Tiago Correia, Wilsthire (GB); Graham Wilkins, Wiltshire (GB)

(73) Assignee: Tyco Electronics UK LTD, Wiltshire (GB)

(21) Appl. No.: 17/704,727

(22) Filed: Mar. 25, 2022

Related U.S. Application Data
(63) Continuation of application No. PCT/EP20/76883, filed on Sep. 25, 2020.

(30) Foreign Application Priority Data
Sep. 27, 2019 (EP) 19200049.5

(51) Int. Cl. C08L 27/18; C08L 23/14; C08L 51/00; C08L 27/20; C08F 214/18; C08F 222/06; C08J 3/28

(52) U.S. Cl. CPC C08L 27/18; C08L 23/14; C08L 51/003; C08L 27/20; C08L 2201/08; C08F 222/06; C08J 3/28; C08L 2205/02; C08L 2312/06; C08F 214/184

(57) ABSTRACT

A cross-linkable composition includes an elastomeric fluoropolymer and a semi-crystalline fluoroplastic. The composition enables manufacturing of articles which maintain favorable mechanical properties (e.g. tensile strength, elongation and flexibility) when continuously exposed to extreme temperatures. In addition, a cross-linked product obtained by subjecting said composition to ionizing radiation is disclosed, which may be used in heat-shrinkable articles, cable jackets and sealing elements.

### CROSS-REFERENCE TO RELATED APPLICATIONS

This application is a continuation of PCT International Application No. PCT/EP2020/076883, filed on Sep. 25, 2020, which claims priority under 35 U.S.C. § 119 to European Patent Application No. 19200049.5, filed on Sep. 27, 2019.

### FIELD OF INVENTION

The present invention relates to a blend of a fluoroelastomer and a semi-crystalline fluoroplastic which can be crosslinked for excellent heat resistance, chemical resistance and mechanical properties.

### BACKGROUND

Fluoropolymer compositions have been widely used in a variety of applications involving high temperatures and aggressive chemicals, such as heat-shrink products, seals, gaskets, O-rings, hoses and cable jackets in industrial, automotive, aerospace and/or oil well drilling equipment, for example.

Numerous efforts have been made to improve the mechanical properties of fluoropolymer-based materials. For example, US 2002/177664 A1 discloses fluoropolymer compositions, wherein particles of a semicrystalline fluoropolymer latex having a specific average particle size range are embedded in a fluoroelastomer matrix to provide favorable elastic retention properties and a smooth surface in the final product. US 2006/0142491 A1 discloses a processable rubber composition containing particles of a vulcanized fluorocarbon elastomer dispersed in a matrix of a thermoplastic polymeric material.

In order to advantageously combine the stability and chemical inertness of perfluorinated monomer units with enhanced elastomeric properties, U.S. Pat. No. 7,476,711 B2 proposes melt blending of a perfluoroelastomer and a semi-crystalline copolymer with a particle size greater than 100 nm, adding a curative, and subsequently curing said composition to form a cured article. However, the mechanical properties of the thus obtained articles tend to deteriorate when exposed to high temperatures for prolonged periods of time. Therefore, it would be desirable to provide fluoropolymer compositions which exhibit further improved heat resistance.

In general, crosslinking of fluoroplastics via chemical or radiation crosslinking processes for developing higher temperature rated products such as molded parts or tubings is challenging, particularly since sufficient compatibility of the initial components must be ensured.

In this context, U.S. Pat. No. 5,409,997 A is specifically concerned with the provision of thermally stable fluoropolymer compositions and discloses a radiation-crosslinkable composition comprising a fluoropolymer of ethylene, tetrafluoroethylene and at least one monomer having at least one polyvalent atom in one or more side chains, as well as a coagent comprising a difunctional compound selected from the group consisting of an acrylate or salt of an acrylic acid and compounds wherein the difunctionality is provided by the presence of vinyl, epoxide, peroxide, or glycidal groups. However, the heat resistance of these fluoropolymer compositions, particularly at long-term exposure to temperatures above 240° C., still leaves room for improvement.

In view of the above, it remains desirable to provide fluoropolymer compositions which enable manufacturing articles which maintain favorable mechanical properties (e.g. tensile strength, elongation properties) when continuously exposed to extreme temperatures, both in the low temperature range (e.g. between −75° C. and 0° C.) and high temperature range (e.g. higher than 240° C.).

### SUMMARY

A cross-linkable composition includes an elastomeric fluoropolymer and a semi-crystalline fluoroplastic.

### DETAILED DESCRIPTION OF THE EMBODIMENT(S)

For a more complete understanding of the present invention, reference is now made to the following description of the illustrative embodiments thereof:

Cross-Linkable Fluoropolymer Composition

In a first embodiment, the present invention relates to a cross-linkable composition comprising a blend of: (a) an elastomeric fluoropolymer, and (b) a semi-crystalline fluoroplastic.

In an embodiment, the composition is cross-linkable by ionizing radiation as will be further explained below with respect to the second embodiment.

The terms “polymer” or “fluoropolymer”/“fluoroplastic”, as used herein, generally refer to a polymeric material or fluorine-containing polymeric material having one or more monomer species, including homopolymers, copolymers, terpolymers, and the like.

The term “semi-crystalline fluoroplastic” refers to a fluorine-containing polymeric material with detectable crystalline order (by differential scanning calorimetry, x-ray diffraction, density, and other methods), i.e. having areas of crystallinity with amorphous areas existing between the crystalline areas.

In terms of improved mechanical properties, in an embodiment, the elastomeric fluoropolymer is not perfluorinated, but only partially fluorinated. In an embodiment, the elastomeric fluoropolymer is a copolymer comprising copolymerized units of a perfluorinated monomer and a non-fluorinated or partially fluorinated monomer, optionally with one or more additional types of monomers. The elastomeric fluoropolymer used in the present invention, in an embodiment, contains between 20 to 80 wt.-%, based on the total weight of the elastomeric fluoropolymer, of copolymerized units of perfluorinated monomer and 5 to 80 wt.-% of non-fluorinated or partially fluorinated monomer. In an embodiment, the perfluorinated monomer is a perfluoroalkylene, such as hexafluoropropylene (HFP) or tetrafluoroethylene (TFE), for example. The non-fluorinated or partially fluorinated monomer is selected from partially fluorinated hydrocarbon olefins (such as one or more of vinylidene fluoride, 1,2,3,3,3-pentafluoropropene (1-HPFP), 1,1,3,3,3-pentafluoropropene (2-HPFP), and vinyl fluoride) and non-fluorinated hydrocarbon olefins (such as ethylene, propylene or isobutylene, for example). As non-fluorinated or partially fluorinated monomer, propylene is used in an embodiment. As elastomeric fluoropolymer, an alternating co-polymer of tetrafluoroethylene and propylene (TFE/P) is used. Commercially available examples thereof include, but are not limited to fluoroelastomers selected from the Aflas® 100/150 ranges available from AGC Chemicals Europe and the TBR range by DuPont Performance Elastomers.

The content of elastomeric fluoropolymer is, in an embodiment, between 10 and 95 wt.-%, between 15 and 90 wt.-%, or between between 20 and 80 wt.-% based on the total weight of the composition.

In the cross-linkable composition according to the present invention, the semi-crystalline fluoroplastic may be a co-polymer, such as a co-polymer comprising fluoroalkylene and a perfluoroether as main chain monomers. The fluoroalkylene may be a perfluoroalkylene, such as hexafluoropropylene (HFP) or tetrafluoroethylene (TFE), for example. The perfluoroether is not particularly limited and may include perfluoroalkoxy alkanes derived from (per)fluoroalkylvinylethers (PAVE) CF2-CFORf, wherein Rf is a perfluorinated group with 1 to 6 carbon atoms; or from perfluorooxyalkylvinylethers CF2-CFOX, wherein X is a C1-C12-perfluorooxyalkyl having one or more ether groups. The co-monomeric unit ≥CF2-CF(ORf)-, wherein Rf is a perfluorinated group with 1 to 6 carbon atoms, may be used in an embodiment. Co-monomers in various embodiments include perfluoro(ethyl vinyl ether) (PEVE), perfluoro(propyl vinyl ether) (PPVE) and perfluoro(methyl vinyl ether) (PMVE). In various embodiment, melt-fabricable fluoropolymers include co-polymers such as PFA (TFE/PAVE copolymer), TFE/HFP/PAVE copolymer and/or PPVE and MFA (TFE/PMVE/PAVE copolymer wherein the alkyl group of PAVE has at least two carbon atoms). Among semi-crystalline fluoroplastics, thermoplastic fluoropolymers comprising acid anhydride functional groups have been shown to exhibit favorable compatibility with elastic fluoropolymers.

The expression “acid anhydride functional group”, as used herein, denotes a residual group having two carboxyl groups in one molecule condensed by dehydration.

Suitable acid anhydride functional groups are pendant groups which may be grafted onto one or more of the aforementioned co-monomers (e.g. by replacing a fluorine substituent) or provided independently as pendant group of a co-monomer, i.e. through co-polymerization. Among compounds for grafting onto and thereby becoming part of the semi-crystalline fluoroplastic, maleic acid and maleic anhydride (MAnh) may be used. Maleic anhydride can be halogen-substituted, e.g., dichloromaleic anhydride and difluoromaleic anhydride. Grafting may be brought about by using a grafting compound comprising a linking group (including, but not limited to an unsaturated or saturated hydrocarbon group which is involved in addition or association of radicals (particularly an organic group having an α,β-unsaturated double bond at its terminal), an amino group or a phenol group which is involved in nucleophilic reaction, a peroxy group or an azo group. In an embodiment, linking groups include a group having a carbon-carbon unsaturated bond. The amount of the grafting compound to be used for grafting is usually from 0.01 to 100 parts by weight, or from 0.1 to 20 parts by weight, per 100 parts by weight of the fluorine-containing polymer. In the case of a grafting compound of a polymer type, it may be used in a larger amount (up to about 50 parts by weight). Exemplary grafting methods and optional radical-forming agents used in the grafting process will be known to the skilled artisan and are disclosed in U.S. Pat. No. 5,736,610 A, for example. Commercially available examples of a suitable semi-crystalline fluoroplastics functionalized with acid anhydride functional groups include Fluon® PFA resins available from AGC Chemicals Europe.

In an embodiment, from the viewpoint of processability, the melting point of the semi-crystalline fluoroplastic comprising anhydride functional groups is in the range of from 240° C. to 340° C., or from 290° C. to 320° C.

In addition, the density of the semi-crystalline fluoroplastic may be between 1.5 to 3 g/ml, or between 1.9 and 2.4 g/ml.

The cross-linkable composition according to the present invention, in an embodiment, contains semi-crystalline fluoroplastic in a content between 5 and 90 wt.-% based on the total weight of the composition, between 10 and 80 wt.-%, or between 20 and 70 wt.-%.

While not being limited thereto, favorable tensile strength and flexibility characteristics may be achieved by adjusting the weight ratio of elastic fluoropolymer to semi-crystalline fluoroplastic in the blend to the range of from 10:1 to 1:10, from 4:1 to 1:4, from 3:1 to 1:3, or from 2.5:1 to 1:2.

The compositions according to the first embodiment of the present invention may contain additives commonly used in polymer formulations, such as radiation crosslinking promoters (or so-called prorads); antioxidants; UV-stabilizers; conductive fillers (such as carbon black for imparting electrical conductivity); acid acceptors or scavengers (e.g. zinc oxide); plasticizers, lubricants, and processing aids typically utilized in perfluoroelastomer compounding; and pigments (e.g. titanium dioxide or carbon black). Such additives are typically used in total contents of less than 15 wt.-%, and in an embodiment less than 10 wt.-%, based on the total weight of the cross-linkable composition.

As examples of radiation crosslinking promoters, compounds having at least two ethylenic double bonds, present as allyl, methallyl, propargyl, acrylyl, or vinyl groups may be mentioned, such as triallyl cyanurate (TAC), triallyl isocyanurate (TAIC), triallyl trimellitate, triallyl trimesate, tetraallyl pyromellitate, diallyl isophthalate, diallyl terephthalate, 1,4-butylene glycol dimethacrylate, trimethylolpropane trimethacrylate (TMPTM), diallyl esters of 1,1,3-trimethyl-5-carboxy-3-(p-carboxyphenyl)indane, diallyl adipate, diallyl phthalate (DAP), pentaerythritol trimethacrylate, glycerol propoxy trimethacrylate, liquid poly(1,2-butadiene), tri-(2-acryloxyethyl)isocyanurate, tri-(2-methacryloxyethyl)isocyanurate, and combinations thereof.

Mixtures of crosslinking promoters can be used. In an embodiment, radiation crosslinking promoters are used in a total amount of up to 8 wt.-%, in a total amount of up to 5 wt.-% based on the total weight of the cross-linkable composition, such as from 0.05 to 5 wt.-% or from 0.1 to 3 wt.-%.

As exemplary antioxidants, alkylated phenols, organic phosphite or phosphates, alkylidene polyphenols, thio-bis-alkylated phenols and polymerized derivatives thereof; dilauryl thio-dipropionate, dimyristyl thiodipropionate, distearyl thiodipropionate (DSTDP), and combinations thereof may be mentioned. In an embodiment, the antioxidant(s) is (are) used in a total amount of up to 4 wt.-%, or in a total amount of up to 2 wt.-% based on the total weight of the cross-linkable composition.

Adjusting the type and quantity of components of the cross-linkable composition according to the first embodiment allows for a fine-tuning of toughness and flexibility of the blend, which is then ready for further processing (including molding and/or extrusion, for example). Upon cross-linking, these properties are then stabilized to be maintained even at extreme temperatures.

Cross-Linked Products, Articles Comprising the Same and Methods of Manufacture

In this regard, a second embodiment according to the present invention relates to a cross-linked product obtained by subjecting the composition according to the first embodiment to ionizing radiation. As has been set out above, the cross-linked products exhibit excellent tensile strength and flexibility over a wide range of temperatures, both when subjected to sudden temperature changes (e.g. a heat or cold shock) and to prolonged exposure to extreme temperatures.

In general, the radiation used for cross-linking should exhibit a sufficiently high energy to penetrate the thickness of the fluoropolymer being treated and to produce ionization therein. The energy level used is any energy level which penetrates the thickness of the sample being irradiated under the atmospheric conditions employed, typically at least 0.5 MeV, and in an embodiment from 1 to 10 MeV. Suitable radiation sources include, but are not limited to gamma rays, X-rays, alpha particles, electron beams, photon beams, deuteron beams, and the like, of which electron beam irradiation may be used. Irradiation may be carried out at room temperature or at elevated temperatures.

The irradiation process is desirably performed so that the composition is exposed to radiation for a sufficient time and at sufficient dose to cause an improvement in tensile properties without degradation effects. In this regard, the composition may be subjected to ionizing radiation at a dose level of up to 150 kGy, at a dose level of from 5 to 100 kGy, or at a dose level of from 10 to 80 kGy.

The thus obtained cross-linked products are useful in many applications, such as seals, gaskets, tubes, wire or cable jackets and insulation, and rollers which will be exposed to environments involving extreme temperatures, harsh chemicals and/or high pressure situations.

In a third embodiment, the present invention relates to a heat-shrinkable article comprising the cross-linked product according to the second embodiment. The heat-shrinkable article may comprise additional components used in the preparation of heat-shrink materials. In various embodiments, the heat-shrinkable article is a tubular article prepared by forming a tubing by extruding the cross-linkable composition according to the first embodiment, cross-linking the same by ionizing irradiation, radially expanding the cross-linked tubular article under a heated condition and then rapidly cooling the same in order for it to maintain its expanded shape.

In a fourth embodiment, the present invention relates to cable jackets or sealing elements comprising the cross-linked product according to the second embodiment. The shape of the sealing element is not particularly limited and may include 0-ring, V-ring, and X-ring designs, for example. In addition, the seal element may comprise a multilayer composition, wherein the cross-linked product according to the second embodiment forms at least one layer of the multilayer configuration. While not being limited thereto, cable jackets according to the present invention may also comprise the cross-linked product in a multilayer configuration and/or in a composite (e.g., in composites comprising reinforcing fibers known in the art).

As indicated above, heat-shrinkable articles, cable jackets and sealing elements according to the present invention are particularly useful in equipment exposed to high temperatures and/or temperature changes, such as in aerospace engineering, for example.

In a fifth embodiment, the present invention relates to a process of manufacturing a cross-linked product, comprising the steps of: (i) mixing an elastomeric fluoropolymer and a semi-crystalline fluoroplastic to prepare a crosslinkable composition; (ii) optionally subjecting the crosslinkable composition to a forming step; and (iii) subjecting the crosslinkable composition to ionizing radiation to obtain the cross-linked product.

Various embodiments of the mixture of an elastomeric fluoropolymer and a semi-crystalline fluoroplastic are explained in the context of the first embodiment above. The methods of preparing the blend of the elastomeric fluoropolymer and the semi-crystalline groups in step (i) are not particularly limited and may be suitably chosen by the skilled artisan depending on the compatibility of the polymers. For example, these may include dry-blending, extrusion mixing and/or melt processing.

In the optional step (ii), the cross-linkable composition is subjected to a shaping process. Suitable methods include molding methods (including injection molding, transfer molding, rotational molding, thermoforming and compression molding, for example), extrusion molding, casting, machining, and the like.

Step (iii) comprises subjecting the crosslinkable composition to ionizing radiation to obtain the cross-linked product, as described above in conjunction with the second embodiment.

It will be understood that the features of the first to fifth embodiments may be freely combined in any combination, except for combinations where at least some of the features are mutually exclusive.

### EXAMPLES

In Examples 1 to 4, blends comprising different contents of the fluoroelastomer Aflas® 150FC (commercially obtained from AGC Chemicals) and the semicrystalline fluoroplastic Fluon® PFA EA-2000 (anhydride-functionalized semicrystalline thermoplastic copolymer commercially obtained from AGC Chemicals) have been prepared by twin screw extrusion mixing, using a LabTech co-rotating modular twin screw extruder with a a 5 kW drive motor (≤1200 rpm) and a screw diameter of 20 mm in a standard screw configuration. The heating zones of the twin screw extruder were set up according to Table 1.

TABLE 1

| Heating | | | | | | | | | |
|---|---|---|---|---|---|---|---|---|---|
| Zone1 | | | | | | | | | Zone10 |
| (Feed) | Zone2 | Zone3 | Zone4 | Zone5 | Zone6 | Zone7 | Zone8 | Zone9 | (Die) |
| 300° C. | 305° C. | 310° C. | 320° C. | 330° C. | 330° C. | 335° C. | 340° C. | 345° C. | 345° C. |

Upon mixing, the blends were subjected to tape extrusion, using a 32 mm Baughan Extruder equipped with an Inconel mixing screw (30 to 50 rpm) and the following heating zone setup:

TABLE 2

| Heating | | | | | |
|---|---|---|---|---|---|
| Zone1 | | | | | Head1 |
| (Feed) | Zone2 | Zone3 | Zone4 | Clamp | (Die) |
| 300° C. | 320° C. | 330° C. | 340° C. | 340° C. | 340° C. |

Subsequently, the thus produced tapes were electron beam irradiated at 20 kGy (2 Mrad) and 40 kGy (4 MRad) dosage levels, respectively.

The irradiated tapes and non-irradiated control samples were subjected to tensile strength (i.e. tensile strength at break) and ultimate elongation (i.e. elongation at break) tests according to ISO 37 (type 2 dumb bell test) at 23±2° C., with an initial jaw separation of 50 mm and a jaw separation rate of 100 ±10 mm per minute.

Where applicable, measurements have been repeated upon subjecting the samples to a heatshock at 315° C. for 4 hours, and upon thermal aging for one week at 270° C. prior. In addition, the low temperature flexibility of the irradiated samples has been tested by inspecting the samples for cracks upon exposure to a temperature of −75° C. for 4 hours and subsequent bending. The sample compositions of Examples 1 to 4 and their evaluation are summarized in Table 3.

TABLE 3

| | | | Example | Example | Example | Example |
|---|---|---|---|---|---|---|
| | | | 1 | 2 | 3 | 4 |
| Compositions | | Fluoroelastomer | 40 | 50 | 60 | 70 |
| | | [wt.-%] | | | | |
| | | Semi-crystalline | 60 | 50 | 40 | 30 |
| | | thermoplastic | | | | |
| | | copolymer [wt.-%] | | | | |
| Unirradiated | Initial | Tensile Strength | 15.19 | 11.83 | 5.87 | 0.53 |
| samples | properties | [MPa] | | | | |
| | | Ultimate | 459 | 489 | 610 | 2100 |
| | | Elongation [%] | | | | |
| | After | | Sample | Sample | Sample | Sample |
| | heatshock | | melted | melted | melted | melted |
| | (315° C. | | | | | |
| | for 4 hours) | | | | | |
| After | Initial | Tensile Strength | 15.09 | 13.33 | 11.49 | 9.48 |
| irradiation | Properties | [MPa] | | | | |
| w. 20 kGy | | Ultimate | 483 | 520 | 607 | 827 |
| | | Elongation [%] | | | | |
| | After | Tensile Strength | 11.55 | 9.45 | 8.61 | 6.36 |
| | heatshock | [MPa] | | | | |
| | (315° C. | Ultimate | 482 | 582 | 803 | 1484 |
| | for 4 hours) | Elongation [%] | | | | |
| | After heat | Tensile Strength | 15.44 | 13.51 | 11.01 | 9.08 |
| | aging | [MPa] | | | | |
| | (270° C. | Ultimate | 549 | 590 | 647 | 797 |
| | for 168 hours) | Elongation [%] | | | | |
| | Flexibility | | No | No | No | No |
| | after low | | cracking | cracking | cracking | cracking |
| | temperature | | | | | |
| | treatment | | | | | |
| | (−75° C. | | | | | |
| | for 4 hours) | | | | | |
| After | Initial | Tensile Strength | 16.05 | 14.17 | 15.51 | 12.58 |
| irradiation | Properties | [MPa] | | | | |
| w. 40 kGy | | Ultimate | 471 | 473 | 540 | 522 |
| | | Elongation [%] | | | | |
| | After | Tensile Strength | 13.21 | 11.07 | 10.46 | 9.68 |
| | heatshock | [MPa] | | | | |
| | (315° C. | Ultimate | 518 | 607 | 745 | 897 |
| | for 4 hours) | Elongation [%] | | | | |
| | After heat | Tensile Strength | 14.21 | 14 | 11.45 | 10.56 |
| | aging | [MPa] | | | | |
| | (270° C. | Ultimate | 558 | 627 | 672 | 696 |
| | for 168 hours) | Elongation [%] | | | | |
| | Flexibility | | No | No | No | No |
| | after low | | cracking | cracking | cracking | cracking |
| | temperature | | | | | |
| | treatment | | | | | |
| | (−75° C. | | | | | |
| | for 4 hours) | | | | | |

As shown in Table 3, the tensile strength and ultimate elongation of the unirradiated samples may be suitably adjusted by varying the contents of fluoroelastomer and the semi-crystalline fluoroplastic. While the non-crosslinked samples melt upon exposure to a temperature of 315° C., the irradiated samples maintain their tensile strength and ultimate elongation performance at excellent levels and withstand both heatshocks at 315° C. and long-term heat exposure at 270° C. In addition, the irradiated samples are resistant to cracking at low temperatures (i.e. 75° C.) and maintain their flexibility.

Accordingly, the above results show that the cross-linkable compositions of the present invention enable manufacturing of toughened articles, which maintain favorable mechanical properties when exposed to extreme temperatures.

Once given the above disclosure, many other features, modifications, and improvements will become apparent to the skilled artisan.

What is claimed is:

1. A cross-linkable composition, comprising:
an elastomeric fluoropolymer; and
a semi-crystalline fluoroplastic.

2. The cross-linkable composition of claim 1, wherein the composition is cross-linkable by ionizing radiation.

3. The cross-linkable composition of claim 1, wherein the elastomeric fluoropolymer is partially fluorinated.

4. The cross-linkable composition of claim 1, wherein the elastomeric fluoropolymer is a co-polymer of a fluoroalkylene and an alkylene.

5. The cross-linkable composition of claim 4, wherein the elastomeric fluoropolymer is a co-polymer of tetrafluoroethylene and propylene.

6. The cross-linkable composition of claim 1, wherein the semi-crystalline fluoroplastic is a thermoplastic co-polymer.

7. The cross-linkable composition of claim 6, wherein the thermoplastic co-polymer includes a fluoroalkylene and a perfluoroether as co-monomers.

8. The cross-linkable composition of claim 6, wherein the thermoplastic co-polymer is grafted with anhydride functional groups.

9. The cross-linkable composition of claim 7, wherein the fluoroalkylene is tetrafluoroalkylene.

10. The cross-linkable composition of claim 7, wherein the perfluoroether is a perfluoroalkoxy alkane.

11. The cross-linkable composition of claim 1, wherein the semi-crystalline fluoroplastic has a melting point in the range from 280° C. to 340° C.

12. The cross-linkable composition of claim 1, wherein the semi-crystalline fluoroplastic has a density between 1.5 to 3 g/ml.

13. The cross-linkable composition of claim 1, wherein the elastomeric fluoropolymer is between 10 and 95 wt.-% of a total weight of the cross-linkable composition.

14. The cross-linkable composition of claim 13, wherein the semi-crystalline fluoroplastic is between 5 and 90 wt.-% of the total weight of the cross-linkable composition.

15. The cross-linkable composition of claim 1, wherein a weight ratio of the elastomeric fluoropolymer to the semi-crystalline fluoroplastic is between 10:1 and 1:10.

16. The cross-linkable composition of claim 1, further comprising a radiation crosslinking promoter in a content of up to 8% of a total weight of the cross-linkable composition.

17. A cross-linked product, comprising:
the cross-linkable composition of claim 1, subjected to an ionizing radiation at a dose level of up to 150 kGy.

18. A heat-shrinkable article, comprising:
the cross-linked product of claim 17.

19. A sealing element or a cable jacket, comprising:
the cross-linked product of claim 17.

20. A process of manufacturing a cross-linked product, comprising:
mixing an elastomeric fluoropolymer and a semi-crystalline fluoroplastic to prepare a crosslinkable composition; and
subjecting the crosslinkable composition to an ionizing radiation to obtain the cross-linked product.
